(19) United States
(12) Patent Application Publication
(10) Pub. No.: US 2009/0099956 A1
(43) Pub. Date: Apr. 16, 2009

(54) SYSTEM, METHOD, AND REPO DERIVATIVE FINANCIAL INSTRUMENT AND MARKET FOR CONDUCTING REPO SWAP/CFD TRANSACTIONS

(76) Inventor: Scott E.D. SKYRM, New Canaan, CT (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/248,228

(22) Filed: Oct. 9, 2008

Related U.S. Application Data
(60) Provisional application No. 60/979,488, filed on Oct. 12, 2007.

(51) Int. Cl. G06Q 40/00

(52) U.S. Cl. 705/37

(57) ABSTRACT

A system and method for facilitating a “swap” between the floating and fixed rate markets, and a financial instrument and a market for trading such instruments, based on such transactions. The basis of this new swap/contract is to establish a fixed rate versus floating rate “swap” in the repo market. The floating rate is generally the daily broker averages, but the floating rate could be a quarterly or monthly rate. Quarterly or monthly “floaters” will be more popular in general collateral SWAP/CFD trades.

### CROSS-REFERENCE TO RELATED APPLICATION

This application claims the benefit of U.S. Provisional Patent Application Ser. No. 60/979,488, filed Oct. 12, 2007; which application is incorporated herein by reference in its entirety for all purposes. Co-pending U.S. patent application Ser. No. 12/237,089, filed Sep. 24, 2008 is also incorporated herein by reference in its entirety.

### TECHNICAL FIELD

The present invention relates generally to market systems and transaction methods for trading financial securities, and to securities and derivatives traded thereon.

### BACKGROUND OF THE INVENTION

The Repo and Reverse Repo market (herein called the “Repo Market”) is one of the largest traded fixed income markets in the world. Banks, broker-dealers and investors use the Repo market to invest cash and finance securities. Repo trades represent one of the least expensive ways of financing because each transaction is a collateralized loan. As a result, a “screen based” trading system has developed over the years. Brokers (“IDBs” or Inter-Dealer Brokers) act as intermediaries for broker-dealers and banks. The brokers offer two kinds of repo transactions traded on their computer screens (via direct line or internet), either overnight or term.

### Overnight and Term Markets

An overnight trade is just for one day, and the vast majority of repo transactions are overnight. A term trade can be from two days extending out to a couple of years. But most term trades have maturities within six months. At the present time, there are no other types of Repo transactions traded in the market.

### The “Broker Average”

Brokers publish the weighted average each day for all the securities they trade. The averages are comprehensive of the morning's trading from 7:00 am to 10:00 am. By compiling the weighted averages for one or more brokers, enables it possible to determine the “average” a security traded at during the main trading hours. The broker average rate is determined after the 10:00 am averages are published by the Brokers. We take the weighted average of one or more electronic or voice repo broker screens, to determine the daily average, or set the “floating rate.”

### SUMMARY OF THE INVENTION

Fixed term rates in repo have existed for years, but with the advent of the TERM BAM trade, there is now a term “floating rate” repo trade. In example forms, the present invention provides a system and method for facilitating a “swap” between the floating and fixed rate markets. The basis of this new swap/contract is to establish a fixed rate versus floating rate “swap” in the repo market. The floating rate is generally the daily broker averages, but the floating rate could be a quarterly or monthly rate. Quarterly or monthly “floaters” will be more popular in general collateral SWAP/CFD trades.

In one aspect, the present invention is a method of conducting a repo swap/CFD financial transaction, said method comprising determining a fixed price for a repo market transaction; determining a variable price for a repo market transaction; determining a difference between the fixed price and the variable price; and exchanging an amount based on the difference, between parties to the transaction.

In another aspect, the invention is a method of conducting a financial transaction including swapping between floating and fixed rate markets by establishing a fixed rate versus floating rate swap transaction in the repo market. Optionally, the floating rate is based on the daily broker averages.

In another aspect, the invention is a system for conducting a REPO SWAP/CFD transaction, the system comprising establishing a contract to pay the difference between a fixed rate and an average of floating rates for the life of a trade.

In yet another aspect, the invention is an electronic trading system for conducting SWAP/CFD transactions, comprising identifying cash flows and contract rates of the SWAP/CFD, a fixed rate, and a weighted average of floating rates.

In another aspect, the invention is a financial instrument comprising a repo market SWAP/CFD providing a return based on a differential between a fixed term rate and a floating rate.

In another aspect, the invention is a market for carrying out transactions between parties of the above-described financial instrument.

In still another aspect, the invention is a financial instrument having a value determined by a difference between a fixed value amount for a repo market transaction and a variable value amount for a repo market transaction.

In another aspect, the invention is a financial instrument comprising a derivative based on a repo market transaction.

In another aspect, the invention is a market for carrying out transactions between parties of any of the above described financial instruments.

These and other aspects, features and advantages of the invention will be understood with reference to the detailed description herein, and will be realized by means of the various elements and combinations particularly pointed out in the appended claims. It is to be understood that both the foregoing general description and the following detailed description of the invention are exemplary and explanatory of preferred embodiments of the invention, and are not restrictive of the invention, as claimed.

### DETAILED DESCRIPTION OF EXAMPLE EMBODIMENTS

The present invention may be understood more readily by reference to the following description of the invention. It is to be understood that this invention is not limited to the specific devices, methods, conditions or parameters described herein, and that the terminology used herein is for the purpose of describing particular embodiments by way of example only and is not intended to be limiting of the claimed invention.

The present invention provides a system and method for carrying out a REPO SWAP/CFD transaction. A SWAP/CFD is an agreement between two parties to exchange the difference between two interest rates at the end of the contract. The REPO SWAP/CFD was created to allow counter parties the benefits of taking a position in the repo market without having to physically settle any securities. Securities do not change hands. A REPO SWAP is an OTC agreement to pay the difference between the fixed and floating rates for a specified period of term of the trade. The invention further includes a financial instrument or security based on the disclosed methods, derivative financial instruments based thereon, as well as a market (physical, electronic or otherwise) for carrying out transactions according to the disclosed methods and/or trading said financial instruments.

A REPO SWAP/CFD can be booked either as a traditional SWAP or as a CFD. A CFD is a “Contract For Difference.” A REPO SWAP/CFD is a contract to pay the difference between the fixed rate and the average of the floating rates for the life of the trade. It is traded Over-the-Counter (OTC) and is booked/supported like any OTC fixed income product.

In example forms of the invention, there are no settlement costs, balance sheet implications, fails, or capital charges for a REPO SWAP/CFD. If a trader wanted to speculate between the difference between term fixed and term floating rates, there is no need to actually book two separate trades. The REPO SWAP/CFD allows the trader to take the risk without settling the actual securities.

For example, if a trader believes the current 10 Year Note will become more special in the next couple days, that trader can BUY the 10 Year Note SWAP/CFD for a one week term. The trader now owns the performance of the security for one week at a fixed rate, and is short at the floating rate. The trader generates income when the overnight rates average lower than the fixed term rate.

### Documentation

In example forms of the invention, counter parties will sign or otherwise enter into a SWAP/CFD agreement. The agreement specifies the obligations of both counter parties and the terms of the contract. The agreement can be created as an addendum to the Master Repurchase Agreement or as a separate agreement. The addendum/agreement will specify: payments, day count, calculated interest and settlement amounts, etc. Margin calls will follow the rules outlined in the MRA.

### Reference Value/Price Multiplier

The contract's “reference value” is the equivalent of the “principal amount” for a regular repo trade. The “price multiplier” is the equivalent of the “dirty price,” or price of the underlying security plus accrued interest.

The REPO SWAP/CFD is automatically re-priced each day. The Electronic Trading System will re-calculate the contract's reference value (principal amount) daily. So in the case of a coupon payment or market movement, the contract is automatically re-priced. The Electronic Trading System will calculate interest differentials based on the “reference value” calculated on a daily basis.

### Example Contract Specifications

Contract Size: One Repo SWAP/CFD is equal to $1 mm notional value of the underlying security.

Underlying Securities: U.S. Treasurys, TIPS, Agencys, General Collateral, Corporates, and Equities.

Floating Rate: The “floating rate” or BAM for Treasurys is defined as the weighted average of the two electronic brokers' daily averages. Other Underlying Securities rates can be defined as well within the scope of the invention.

Confirms: Confirms are sent out daily. Trade details and interest accruals can be monitored on the electronic trading system online.

Delivery: No delivery.

Tick Size: 1 tick equals 1 basis point.

Price Quote: Quoted as an interest rate. The term fixed rate is stated and the floating rate is determined daily by the “broker average.”

Contract Months: OTC (Over-the-Counter)—any dates are acceptable.

Trading Hours: 2:00 am New York time to 2:30 pm New York time for CASH (same day settlement). 2:00 am New York time to 4:30 pm New York time for REG and SPOT settle.

Ticker Symbol: SWAP/CFD (subject to change).

Daily Price Limit: None.

Margin Information: Margining specified in MRA. Margin calls at $500,000.

Settling Contract Values: Contract cash flows/differences and settled the day of expiration.

### Booking Trades

The Electronic Trading System keeps track of all outstanding SWAP/CFD's. In the Executions Window, a section named Outstanding trades (shown in example form below) shows the cash flows and contract rates of the SWAP/CFD. One column shows the fixed rate, another column shows the weighted average of floating rates. The last column shows the current cash flows of the trade. The Electronic Trading System will automatically send confirms to any requested recipients. The electronic trading system preferably comprises one or more computers accessible by one or more users, optionally via a communications network, for carrying out transactions, determining and/or recording transaction data, reporting, etc. Traders and back-office personnel will have daily online access to interest accruals on contract settlement payments.

Outstanding Trades

| | | | Today's | BAM | | Today's | Net Cash |
|---|---|---|---|---|---|---|---|
| | | Term | BAM | Average | # of | Price | Flow of |
| SWAP/CFD | Term | Rate | Rate | To Date | Contracts | Multiplier | Contract |
| 10 Year | December 31 | 4.75% | 4.70% | 4.657% | 100 | 102.375 | $1,547.00 |

BUYING the SWAP/CFD is the equivalent of going LONG the security in the term market. BUYING the SWAP/CFD means the buyer is receiving a fixed rate on cash and paying the floating rate on cash. SELLING the SWAP/CFD is the equivalent of SELLING the security term. Selling the SWAP/CFD means the seller is paying a fixed rate on cash and receiving the floating rate. The cash flows reflect the normal structure of the repo market. Overall, the BUYER wants overnight rates to average lower than the fixed rate and the SELLER wants overnight rates to average higher.

### EXAMPLE

### 10 Year Note—1 Week SWAP/CFD—4.80%/4.75%

Suppose the 1 week fixed term rate is 4.75% and the BAM overnight market is trading at a ±0 basis point spread. Assume the underlying 10 Year Note underlying price is trading at 100, including accrued interest. A trader who buys the REPO SWAP/CFD will buy term (fixed) and sell floating. This means the investor invests cash (RECEIVES) a 4.75% fixed rate for the life of the trade and borrows cash (PAYS) a floating rate.

### Cash Flows

BUY: 1 WEEK REPO SWAP/CFD—Trader is long the 1 week security and short the 1 week BAM—The trader is “LONG” the market.

The Cash Flow Formula Is:

Number of contracts*“reference value”*rate*# of days/360.

The “reference value” of the contract is the price+accrued interest of the underlying security divided by 100.

TERM Interest Cash Flows:

100 mm 4.75% for 7 days=100,000,000*(100)*0.0475*7/360=$92,361.11

BAM Interest Cash Flows:

100 mm*(100)*(4.75%, 4.65%, 4.55%, 4.55% 4.70% (3 days on Friday))[average rate is 4.6571428]/360=$90,555.50

SWAP/CFD value at the end of the contract is $1,805.61

The buyer of the REPO SWAP/CFD receives $1,805.61. The seller of the REPO SWAP/CFD pays $1805.61.

### Additional Features and Advantages:

Minimal Transaction Costs—Traders can speculate on the direction of the repo market or individual securities without settling securities. There is no balance sheet usage, clearing securities, and with no risk of fails.

Substitute For Term Repo—Traders no longer need to lock-in term repo trades. If a trader wants to lock-in the term rate, a trader can take a long or short SWAP/CFD position.

New Product—It's a new tool to trade in the repo market, offering additional products for clients.

Interest Rate Hedge—Traders can hedge in the Term general collateral. Markets or proprietary trading positions without having to finance the security term.

Reduced Costs of Hedging Risk—Hedge Funds can lock-in term rates without the costs involved with a prime broker. A trader at a hedge fund must consider added costs of repo execution for trading decisions. Prime Brokers charge several basis points for term trades and additional basis points to close the position. With the REPO SWAP/CFD, the trader only pays 1 basis point of both sides of the trade.

Arbitrage—Traders can arbitrage the REPO SWAP/CFD market versus the traditional term repo market.

Added Leverage—traders can leverage their trades without increasing balance sheet usage.

### TRADING EXAMPLES

Basis Trade—A basis trader is LONG the BASIS (long the security and short the futures contract). The trader can normally lock-in funding in the term repo market. In the past, the trader is forced to pay a bid/offer spread in the term repo market and transaction costs. If the trader gets out of the cash position, he must unwind the repo trade. Instead, the same trader can SELL the security to the delivery date as a REPO SWAP/CFD. The trader continues to finance the positions daily, but has a fixed rate locked-in until delivery. If he chooses to close the position, he only needs to unwind the REPO SWAP/CFD and there are no balance sheet implications.

Basis Trade: “Box” Position—Hedging risk with a REPO SWAP/CFD does not involve settling securities. Suppose a basis trader wants to lock-in term financing, but does not want to actually deliver securities. That trader can continue to finance securities in the “box” and lock-in term financing rates.

Synthetic Term Floating Rate—The REPO SWAP/CFD can be used in combination with term repo rates. Suppose the current 10 Year Note term to November 15 is trading at 4.15% and the 10 Year Note SWAP/CFD is also at 4.15%. If the trader wanted to lock-in term funding “at the broker average,” he could BUY the 10 year note term at 4.15% and SELL the SWAP/CFD at 4.15%. This would lock-in broker average term funding to November 15. Since the SWAP/CFD could be trading at a spread to the term repo rate, a trader could synthetically lock-in a spread above or below the daily broker average.

Better Hedge For Term General Collateral—A trader who hedges term general collateral or short coupons with Fed Funds futures contracts will have a better hedge. The hedge is no longer susceptible to movements in the spread between G.C. and fed funds, which can be volatile.

Shorting Term General Collateral—Traders never had a good way to get short term general collateral. There was always this bias in the market. It is easy to go LONG, but difficult to go SHORT. Getting SHORT means selling an issue term. If you do not own that specific security, you need to borrow that specific security each day and pay a premium for the specific security. The repo market invented the GCF trade several years ago to address this. However, GCF term trades trade at a discount. Sometimes as much as 5 basis points. A trader can SELL a G.C. SWAP/CFD and effectively get short term, while covering back at the daily floating rate.

Substitutions In Term G.C.—When traders trade Term G.C., they generally must allow collateral substitutions. The G.C. SWAP/CFD does not require any substitutions.

Hedge Structured Repo—Structured Repo trades involve G.C. trades which reset rates at certain times or under certain events. Instead of hedging these trades with futures and/or options, repo traders can hedge with G.C. SWAP/CFD's. This generates a better hedge.

Term Corporate Bonds/Equities—Many Corporate bond repo traders charge large premiums to sell Corporates/Equities term for fear of buy-ins. A SWAP/CFD is not affected by buy-ins. It is the difference between a floating rate (daily) and the term rate and settlement issues do not affect it.

CDS—CDS traders can more easily arbitrage swaps versus cash bonds with no balance sheet implications.

While the invention has been described with reference to preferred and example embodiments, it will be understood by those skilled in the art that a variety of modifications, additions and deletions are within the scope of the invention, as defined by the following claims.

What is claimed is:

1. A method of conducting a repo SWAP/CFD financial transaction, said method comprising:
determining a fixed rate for a repo market transaction;
determining a variable rate for a repo market transaction;
determining a difference between the fixed rate and the variable rate; and
exchanging an amount based on the determined difference, between parties to the transaction.

2. The method of claim 1, wherein the fixed rate is based on a fixed term rate for a stated period and the variable rate is based on a daily average floating rate for the stated period.

3. The method of claim 1, wherein the variable rate is based on a quarterly average floating rate.

3. The method of claim 1, wherein the variable rate is based on a monthly average floating rate.

4. The method of claim 1, wherein the variable rate is determined based on a weighted average of at least two broker daily averages.

5. The method of claim 1, further comprising executing a SWAP/CFD agreement between the parties to the transaction specifying terms of the transaction.

6. The method of claim 1, wherein the repo market transaction is based on an underlying security selected from U.S. Treasuries, TIPS, Agencies, General Collateral, Corporates, and Equities.

7. A method of conducting a repo swap/CFD financial transaction, said method comprising swapping between floating and fixed rate markets by establishing a fixed rate versus floating rate swap instrument in the repo market.

8. The method of claim 7, wherein the floating rate is based on one or more daily broker averages.

9. A system for conducting a REPO SWAP/CFD transaction, said system comprising establishing a contract to pay the difference between a fixed rate and an average of floating rates for the life of a trade.

10. The system of claim 9, further comprising establishing a market for trading the contract between parties.

11. An electronic trading system for conducting a plurality of SWAP/CFD transactions, comprising an online network for identifying cash flows and contract rates of the SWAP/CFD transactions, based on a fixed rate and a weighted average of floating rates.

12. A financial instrument comprising a repo market SWAP/CFD providing a return based on a differential between a fixed term repo rate and a floating repo rate.

13. A financial instrument having a value determined by a difference between a fixed value amount for a repo market transaction and a variable value amount for a repo market transaction.

14. A financial instrument comprising a derivative based on a repo market transaction.

15. A market for carrying out at least one transaction between parties of at least one financial instrument comprising a repo market SWAP/CFD providing a return based on a differential between a fixed term repo rate and a floating repo rate
